(19) United States
(12) Patent Application Publication
(10) Pub. No.: US 2003/0017245 A1
(43) Pub. Date: Jan. 23, 2003

(54) Novel aspartame powders

(76) Inventors: Rickey E. Seigler, North Augusta, SC (US); Kerry R. Kenny, Augusta, GA (US); Barbara Bryant, Belvedere, SC (US); Lito G. Castelo, Evans, GA (US)

Correspondence Address: Jeffrey M. Hoster, The NutraSweet Company, Suite 1-400, 200 World Trade Center - Merchandise Mart, Chicago, IL, 60654, US

(21) Appl. No.: 10/109,436

(22) Filed: Mar. 28, 2002

Related U.S. Application Data
(60) Provisional application No. 60/281,216, filed on Apr. 3, 2001.

(51) Int. Cl. A23L 1/236

(52) U.S. Cl. 426/548

(57) ABSTRACT

A process is described in which compacted aspartame is treated by milling to produce aspartame powder having a substantial portion of particles less than 20 μm, while obtaining a greater bulk density than commercially available aspartame powders having similar particle size distributions. Air classification can also be used to produce an aspartame powder having a substantial amount of particles less than 20 μm and having a high bulk density. Aspartame powders having this particle size distribution and bulk density possess exceptionally good properties as regards to bulk density and flow.

This application claims the priority of U.S. Provisional Patent Application Serial No. 60/281216, filed on Apr. 3, 2001.

### FIELD OF THE INVENTION

This invention relates to a process of producing novel aspartame powders which have particle size distributions comprising large amounts of fine particles, and also possess high bulk density. The aspartame powders are less dusty and have improved flow properties compared to commercially available aspartame powders.

### DESCRIPTION OF THE PRIOR ART

Aspartame is used widely as a sweetener in a variety of food, beverage and pharmaceutical products. Powder forms of aspartame are used, sometimes as a blend with other sweeteners, in products such as table-top sweeteners, powder soft drinks, chewing gums, and instant dessert products. Dry mixtures and blends of aspartame with other sweeteners or bulking agents are commonly referred to as powder mixtures.

The usefulness of aspartame powder in these applications depends on a number of characteristics. Good flow behavior is desired for processing and ease of handling. The ability to mix well and remain mixed with other ingredients is important for maintaining particle homogeneity of the powder mixture. A high bulk density allows for a reduction of bulk and ease of mixing with other ingredients, with less packaging required. A quick dissolution rate is important for table-top and powder soft drink applications. Dusting of the product has to be minimal or entirely eliminated to avoid loss of product. Practically however, it inherently is difficult to produce an aspartame powder which has all of these properties for every type of sweetening application. It therefore remains an objective to produce aspartame powders that have advantages for specific sweetening applications.

Attempts to improve the above mentioned properties have been made by producing aspartame powders which have specific particle size distributions. For example, U.S. Pat. No. 6,039,275 discloses an aspartame powder with improved properties for application in instant powder mixtures and instant desserts. A substantial portion of the fine particles (hereafter “fine” particles are defined as those smaller than about 20 μm) are removed by a fines sifter and the aspartame powder that is produced is comprised of mostly particles larger than 20 μm, specifically, the particle distribution is such that the powder does not comprise more than 10 wt. % of the particles smaller than 20 μm. Because of the large reduction of smaller particles, the powder has advantages of less dusting and was also shown to have improved dissolution rates when dissolved in a citric acid solution. U.S. Pat. No. RE36,515 describes a multistage fractionation process in which an aspartame powder is produced having a particle size distribution where 97% of the particles are within the size range between 20 μm and 250 μm. Similar to that described in U.S. Pat. No. 6,039,275, most of the particles smaller than 20 μm were removed, leaving as the desired product an aspartame powder having improved properties with regards to dusting and dissolution rate. U.S. Pat. No. 5,834,018 also discloses a process which uses a stream of air for the removal of fine particles.

Using this air classification process, particles of sizes smaller than 20 μm were removed from the starting aspartame powder. After removing a substantial portion of the fine particles, the resulting aspartame powder had a particle size distribution in which at least 94% of the particles had sizes greater than 20 μm. The resulting aspartame powder was reported to have improved properties with respect to dustiness and flow.

It appears from these disclosures that the powder properties of aspartame can be improved by removing the smaller particles, in particular particles smaller than 20 μm. As a consequence, the removal of the fine particles results in an aspartame powder having a particle size distribution which comprises particles greater than 20 μm. These disclosures teach that removal of the fine particles decreases the potential for dusting, as well as improving the dissolution rate, ease of handling and flow of the aspartame powder.

Based on a review of the prior art, an aspartame powder which has a particle size distribution where a substantial portion of the particles is smaller than 20 μm, while at the same time providing an improvement of flow and dusting properties, has not been disclosed. Surprisingly, the combination of particle size distribution in which a substantial portion of the aspartame particles is smaller than about 20 μm, and high bulk density can be used to overcome undesired dustiness, poor dissolution, and powder flow problems of commercially available powder aspartame. None of the commercially available aspartame powders are comprised of a substantial portion of particles smaller than 20 μm while having, at the same time, the property of high bulk density. It has been discovered that these types of aspartame powders can be produced by a process of milling compacted aspartame. The improvement of powder flow properties provided by an aspartame powder comprised of a large portion of particles smaller than 20 μm would not have been predicted from previous disclosures since the goal always has been the removal of such particles. The aspartame powders of the present invention are particularly suitable for applications requiring encapsulated and tablet forms of aspartame, and provide greater flexibility in the preparation of foods and beverages that require powder forms of the sweetener, in particular, those such as table-top, powdered soft drinks and chewing gum compositions.

### SUMMARY OF THE INVENTION

This invention relates to the preparation of aspartame powders by milling compacted aspartame, where the resulting particle size distribution of the obtained aspartame powder is comprised of a substantial portion of particles smaller than about 20 μm, while at the same time having a high bulk density. The aspartame powders produced have a higher bulk density compared to commercially available aspartame powders having similar particle size distributions. The aspartame powders exhibit less dusting than what would normally be encountered for aspartame powders comprising fine particles, and are particularly suited for sweetening applications where a combination of fine particle size and high bulk density is desired. The present invention also relates to food products sweetened with aspartame powders comprising particle size distributions of the present invention and high bulk density.

### DESCRIPTION OF THE PREFERRED EMBODIMENTS

A preferred embodiment of the invention is milling compacted aspartame to produce aspartame powders having particle size distributions in which about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm. The resulting aspartame powder has a bulk density of 0.15-0.35 g/cm³. Another preferred embodiment of the invention is classifying the aspartame powder produced from the milled compacted aspartame to produce an aspartame powder having a particle size distribution in which about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm. The resulting aspartame powder has a bulk density in the range of 0.45-0.70 g/cm³.

An important property of aspartame powders is its particle size distribution. Aspartame powders consisting of specific particle size distributions can be prepared by processes which either separate or fractionate particular size ranges, thereby decreasing the amount of one size fraction while increasing the amount of the other size fractions. Removal of particles smaller than 20 μm conventionally has been desirable as this improves dusting and flow properties of commercially available aspartame powders. While these improvements can be made by altering the particle size distribution to consist of larger size fractions, it is still desirable in many respects to use aspartame powders consisting of particle size fractions containing particles less than 20 μm, as these powders will be advantageous for use in many powdered sweetening applications due to their improved dissolution and dusting properties.

Another important property of aspartame is its bulk density. Bulk density can be defined as the mass of a substance divided by the volume it displaces, and therefore the bulk density of aspartame will often govern its use in sweetening applications that require aspartame powder. For example, an aspartame powder having a low bulk density (i.e. <0.2 g/cm³) will be lightweight and have a greater surface area, making it suitable for certain table-top applications (e.g. products having spoon for spoon equivalency with table sugar) but unsuitable for most other powder applications such as blends with other sweeteners and other powder ingredients. An aspartame powder having a high bulk density (i.e. >0.4 g/cm³) will be much more compact and dense, exist as harder particles, and as a consequence result in a more flowable product compared to the aspartame of lower bulk density. Typically, aspartame having a higher bulk density will also result in a powder that dusts less than one of low bulk density. Bulk density is very important in the formulations of powder blends as the densities of the individual ingredients need to be similar in order to prevent segregation of particles. Generally, a higher bulk density aspartame is desired over a lower bulk density aspartame for most aspartame powder applications since the amount of aspartame that can be delivered will be provided as particles having a smaller overall volume.

An aspartame powder which has a large amount of fine particles in conjunction with the particles having a high bulk density will provide many advantages in powder sweetening applications. Because of the high bulk density, the finer particles will be distributed more uniformly in the preparation of tabletop and powder soft drink formulations, especially those formulations which use preparation processes of agglomeration and annealing. Fine particles having high bulk density will be able to better avoid segregation of ingredients before packaging and exhibit less dustiness. The product will also have improved utility in chewing gum as the denser fine particles will result in encapsulated particles that are smaller, and therefore be distributed more uniformly within a chewing gum matrix.

According to the present invention, aspartame powders having a particle size distribution comprising a large fraction of small particles and having a high bulk density can be prepared by a process of milling compacted forms of aspartame. With regards to this patent application, a compacted form of aspartame is defined as aspartame which has undergone a process which results in a reduction of overall volume of the initial aspartame material. Typically, compacted forms of aspartame are produced from powder aspartame by mechanical compaction methods. Types of compacted aspartame that are commercially available include those manufactured by Ajinomoto (Granular GT brand, Tokai, Japan) and The NutraSweet Company (Granular GA brand, Augusta, Ga.). A common method of compaction is roll compaction, which results in forming a uniform, compacted sheet of aspartame. The compacted sheets are then broken up to provide granular forms of aspartame. The overall process produces aspartame granules having relatively large particle sizes and irregular shapes. Though roll compaction is commonly used, the aspartame can be compacted by any known process and the present invention is not limited to the type of compacting process. The present invention is also not limited by size or shape of granules produced from the compaction processes. The present invention relates to a process of milling any compacted form of aspartame under conditions sufficient to produce an aspartame powder having the desired particle size distribution and bulk density.

A preferred process of the present invention involves converting compacted aspartame to an aspartame powder by impact milling. Impact milling is a process which grinds or pulverizes the starting material by use of rotating moving hammers, thereby causing particle size reduction. Some examples of impact mills are type C Hosokawa MikroPul mills (Hosokawa Micron Powder Systems, Summit, N.J.), type R Fine Granular Pulverizer mills (Buffalo Hammer Mill Corp., Buffalo, N.Y.), and Rotormill Grinders (International Process Equipment Company, Pennsauken, N.J.). Two types of impact mills were used to produce aspartame powder according to the present invention; these were (1) a Pulvercron PC20 (Strong-Scott Manufacturing Company, Winnipeg, Canada) mill and (2) a Mikro-Pulverizer mill (MicroPul Corporation, Summit, N.J.). The Pulvercron PC20 mill is an airswept pulverizer equipped with beaters (i.e. hammers) that are rotated around the periphery of the grinding chamber, causing the feed material to undergo particle size reduction by the beaters interaction against the feed material and surface liner of the chamber. An air-stream controlled by vacuum continually sweeps the pulverized material across the grinding chamber. The Mikro-Pulverizer mill is equipped with a rotor assembly fitted with stirrup type hammers, a multiple deflector liner, an optional retain screen and a feed screw mechanism whereby the compacted aspartame is fed uniformly into the grinding chamber.

The particle size distribution of the aspartame powder obtained after milling is dependent on the rate of aspartame fed into the mill and the rate of rotor rotation. In general, a rotor rotation rate will be used which corresponds to the rate of fed material while maintaining the desired yield and overall efficiency of the process. In addition, many milling devices are equipped with optional retain screens which collect oversized particles during milling; the particles are then recycled back to the feed material to be re-milled. A retain screen often is preferred since large particles that fall outside the desired particle size range are recycled back as part of the feed material, thus limiting the loss of the ground aspartame and improving efficiency. Thus, both feed rate and rate of rotor rotation can vary in accordance with the size of the retain screen in order to compensate for the recycled material. Furthermore, the feed rate and rotor rotation rate will be different for different types of milling devices due to the size and types of hammers used. It is anticipated that one of ordinary skill in the art can make adjustments in the feed and rotor rotation rates for a particular milling device in order to produce aspartame powder having the desired particle size distribution while at the same time keeping in mind the efficiency and yield of the process.

The feed rate, rotor rotation rate and retain screen parameters was evaluated using the Pulvercron PC20 and Mikro-Pulverizer mills. The resulting aspartame powder had the following particle size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm. Preferably, the particle size distribution is such where about 30 to about 60 wt. % of the particles are smaller than 5 μm, about 20 to about 30 wt. % of the particles are between 5-21 μm; about 5 to about 15 wt. % of the particles are between 21-51 μm; about 2 to about 10 wt. % of the particles are between 51-87 μm; and less than about 5 wt. % of the particles are greater than 87 μm.

Using the Pulvercron PC20, a feed rate of 250 to 450 kg/hr and rotor rotation rate of 3000-5000 rpm was used, while a feed rate or 350-450 kg/hr and rotor rotation rate of 3000-4500 rpm was used to produce aspartame powder having the preferred particle size distribution. Aspartame powder was also produced using the Pulvercron PC20 equipped with a retain screen. In this case the Pulvercron PC20 was fitted with a 48 ″ Sweeco 120T retain screen which recycled particles greater than about 100 mesh (149 μm) back to the feed material to be re-milled. Using the Pulvercron PC20 mill in this manner, a feed rate of 100 to 150 kg/hr in conjunction with a rotor rotation rate of 2300 to 5600 rpm was used, while a feed rate of 100-130 kg/hr and rotor rotation rate of 2300-4500 rpm was used to produce aspartame powder having the preferred particle size distribution. Using the Mikro-Pulverizer, a feed rate of 100 to 150 kg/hr in conjunction with a rotor rotation rate of 3000-6500 rpm was used, while a feed rate of 100-120 kg/hr and rotor rotation rate of 5000-6500 was used to produce aspartame powder having the preferred particle size distribution.

The aspartame powder of the present invention also has a substantial portion of particles smaller than 5 μm. This is all the more surprising since aspartame powders containing a large portion of particles of this size range would not be expected to possess high bulk densities while at the same time exhibit improved flow properties. Preferably, the powder produced is comprised of about 40 to about 95 wt. % of particles less than about 20 μm. The aspartame powder produced has a bulk density in the range of 0.15-0.35 g/cm³, and more preferably, a bulk density of 0.20-0.35 g/cm³.

At conditions of milling with or without a retain screen, the process is not limited by the amount of particles smaller than about 20 μm that are produced, although for practical purposes very high amounts (i.e. >95 wt. %) of fine particles, if produced, will generally result in too much loss of product for economical processing.

Under a second embodiment, an aspartame powder having a substantial portion of particles smaller than about 20 μm and a high bulk density also can be produced by removing a portion of the fine particles of the aspartame powder obtained from the previously described impact milling process. By reducing the amount of the particles smaller than 20 μm to about 20 wt. % to about 50 wt. %, the aspartame powder produced has a particle size distribution such that it has a significantly higher bulk density compared to that of commercially available aspartame powders having similar particle size distributions. The aspartame powder produced also has a higher bulk density compared to commercially available aspartame powders that have particle size distributions comprised of larger amounts of large particles. The aspartame powder so produced still has a substantial portion of particles less than about 20 μm, yet possesses an even higher bulk density than that of the aspartame produced directly from milling compacted aspartame.

The process of producing the aspartame powder under this embodiment is achieved by removing a portion of the fine particles by classification of the particle size distribution. Reducing the portion of smaller particles naturally results in a concomitant increase in the amount of particles of higher size ranges. The particle size distribution of the classified powder is such that about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm. Preferably, the particle size distribution is such that about 10 to about 30 wt. % of the particles are smaller than 5 μm, about 10 to about 30 wt. % of the particles are between 5-21 μm; about 30 to about 50 wt. % of the particles are between 21-51 μm; about 15 to about 25 wt. % of the particles are between 51-87 μm; and less than about 10 wt. % of the particles are greater than 87 μm. Preferably, the powder produced is comprised of about 20 to about 50 wt. % of particles less than about 20 μm. The aspartame powder so produced has a bulk density in the range of about 0.35-0.70 g/cm³, and more preferably in the range of about 0.45-0.70 g/cm³.

It is contemplated that the aspartame powder of the present invention can be produced by any means of classification. Preferably, the aspartame powder is produced by air classification. Air classification is a process that uses a combination of air and sifting to separate particles of various sizes into specific size ranges. Traditional sieving techniques or other fractionation techniques cannot be used adequately if the amount of fine particles contained in the aspartame powder prior to classification is greater than about 30 wt %, simply because the starting aspartame either will fail to fluidize correctly in the fluid bed or will cause screen plugging. Therefore, the process of air classification is ideal for the classification of aspartame powders having a substantial portion of particles smaller than about 20 μm. Because of the fact that the starting aspartame powder is comprised of at least 30 wt. % of particles less than 5 μm, the processes of U.S. Pat. Nos. RE36,515 and 5,834,018 are not suitable for classification of these types of aspartame powders.

Under the conditions of the present invention, the aspartame powder so produced has a substantially higher bulk density than aspartame powders which have particle size distributions comprising fractions of particles substantially greater than about 20 μm. The combination of particle size distribution and high bulk density of aspartame prepared by the present invention is unique compared to commercially available aspartame powders.

Common examples of air classifiers include type CS Hosokawa Mikropul cyclone sifter (Hosokawa Micron Powder Systems, Summit, N.J.) and RSG TD series air classifiers (RSG Inc., Sylacauga, Ala.). The air classifier experimentally used was the Hosokawa Micron Separator, Model No. MS-2 (Hosokawa Micron Powder Systems, Summit, N.J.). In general, the air classifier consists of a classifier rotor mounted either in a horizontal or vertical position. The classifier rotor can be driven at variable speeds. The powder fed into the classifier is conveyed by a stream of air. Particles of pre-selected size are carried through the rotor airway slits by a secondary air flow controlled by vacuum and are transported to the outlet and collected. Typically, an air flow is maintained which corresponds to 18″ to 30″ vacuum. Any rejected particles descend to the bottom of the classifier and are collected.

The process of producing an aspartame powder having the desired particle size distribution and high bulk density depends on the combination of rate of aspartame feed and the rotation speed of the classifier rotor. The process comprises the steps of feeding previously milled aspartame powder into the Hosokawa Micron Separator at a rate of about 1 to about 2.5 kg/min while maintaining the classifier rotor rotation rate of between about 1000 to about 1700 rpm. A feed rate of about 1 to about 2.0 kg/min and classifier rotor rotation rate of between about 1500 and 1700 rpm was used to produce aspartame powder having the preferred particle size distribution.

The invention will now be illustrated by reference to Examples 1-4. The particle size distributions of the powder aspartame samples were determined using a Sympatec HELOS Type KFS Particle Size Analyzer (Princeton, N.J.), which uses laser-light diffraction as the means to determine particle sizes of powders. Bulk densities were determined for each aspartame powder by measuring the weight of a specific volume of powder and recording the results.

### EXAMPLE 1

### Aspartame Powder Obtained from Milling Compacted Aspartame

Aspartame powder having the desired particle size distribution and bulk density was obtained by milling compacted aspartame directly. Compacted aspartame (Ajinomoto GT) was obtained directly from The Ajinomoto Company (Tokai, Japan). The compacted aspartame was milled using a Pulvercron PC20 mill (Strong-Scott Manufacturing Company, Winnipeg, Canada). Two different rotor rotation rates were used. In Trials 1-3, a rotor rotation rate of 4200 rpm was used, while in Trial 4 a rotor rotation rate of 5000 rpm was used. In each trial the compacted aspartame was fed into the grinding mill using a feed rate of 400 kg/hr, while maintaining a mill vacuum of 27″.

The particle size distributions and bulk densities of the resulting aspartame powders are shown in Table 1, and are also compared to the particle size distributions and bulk densities of Product A and Product B. Use of the different rotor rotation rates resulted in an aspartame powder having different particle size distributions, in particular, the amount of particles less than 5 μm and within the 5-21 μm range. Aspartame powders obtained from using a rotor rotation rate of 4200 rpm yielded a distribution in which about 57-59 wt. % of the particles were less than 5 μm, while having a bulk density of 0.24-0.25 g/cm³. The amount of particles in the range of 5-21 μm was around 28-29 wt. %, thus, the total amount of particles less than about 21 μm was about 85-88 wt. %. The aspartame powders obtained in Trials 1-3 had similar particle size distributions when compared to Product B, however, the bulk densities were significantly higher. The aspartame powders obtained in Trials 1-3 were less powdery, less dusty and flowed more uniformly when compared to either Product A or Product B.

The aspartame powder obtained from Trial 4 was comprised of even smaller particles; the amount of particles less than 5 μm was 80.9 wt %, while the amount of particles in the range of 5-21 μm was 17.2 wt. %, resulting in an overall amount of particles less than about 21 μm of 98.1 wt. %. Compared to either Product A or Product B, the aspartame powder had a substantial amount of particles that was less than 21 μm, while also having a higher bulk density. This aspartame powder was also less powdery, less dusty and flowed more uniformly than either Product A or Product B.

TABLE 1
Properties of Aspartame Powders Obtained
From Milling Compacted Aspartame

| Aspar- | | | | | | Bulk |
|---|---|---|---|---|---|---|
| tame | wt. % | | | | | density |
| powder | <5 μm | 5-21 μm | 21-51 μm | 51-87 μm | +87 μm | g/cm³ |
| Trial 1 | 58.9 | 28.5 | 8.8 | 3.8 | 0.0 | 0.24 |
| Trial 2 | 57.9 | 28.8 | 9.6 | 3.6 | 0.2 | 0.25 |
| Trial 3 | 56.8 | 28.0 | 8.9 | 4.2 | 2.1 | 0.25 |
| Trial 4 | 80.9 | 17.2 | 1.9 | 0 | 0 | 0.23 |
| Product | 29.7 | 46.3 | 19.2 | 4.8 | 0.0 | 0.20 |
| A | | | | | | |
| Product | 68.6 | 27.6 | 3.6 | 0.2 | 0.0 | 0.14 |
| B | | | | | | |

### EXAMPLE 2

### Aspartame Powder Obtained from Milling Compacted Aspartame With Recycle of Oversize Particles

The process described in Example 1 was repeated with the objective of producing aspartame powder having the desired particle size distribution, but by reducing both the rotor rotation and feed rates. Two trials were carried out using as starting material Ajinomoto GT compacted aspartame. The same process conditions were used as in Example 1 except Trial 2 included the use of a retain screen to recycle any oversized particles produced. The Pulvercron PC20 mill was fitted with a 48 inch 140T Sweeco retain screen which collected particles larger than about 125 μm. These oversized particles were then returned to the feed material and subsequently milled. In both trials the a feed rate of 130 kg/hr, rotor rotation rate of 2350 rpm and mill vacuum of 29″ were used.

The bulk density and particle size distribution properties of the resulting aspartame powders are shown in Table 2, along with their comparison to the commercially available aspartame powders Product A (Ajinomoto) and Product B (NutraSweet). The particle size distributions and bulk densities of Trial 1 and Trial 2 were similar; the only significant difference was that Trial 2 resulted in a higher yield of aspartame powder due to the recycling of the oversized particles. The fraction of particles smaller than 5 μm was about 50 wt. % in each trial, and the amount of particles in the range of 5-21 μm was between about 26-29 wt. %. Thus, the total amount of particles less than 21 μm was about 76.5-76 wt. %. The other size ranges of the two powders were also similar. The particle size distributions of the aspartame powders obtained in Trials 1 and 2 are similar to that of Product B; however, the bulk densities were nearly twice that of Product B. Similarly, a comparison of the aspartame powders obtained in Trials 1 and 2 to Product A indicates that the bulk densities are significantly higher, even though Product A has virtually the same amount of particles less than 21 μm. The higher bulk density aspartame powders obtained in Trials 1 and 2 were less powdery, less dusty and flowed more uniformly when compared to that of either Product A or Product B.

TABLE 2
Properties of Aspartame Powders Obtained From Milling
Compacted Aspartame With Recycle of Oversize Particles

| Aspar- | | | | | | Bulk |
|---|---|---|---|---|---|---|
| tame | wt. % | | | | | density |
| powder | <5 μm | 5-21 μm | 21-51 μm | 51-87 μm | +87 μm | g/cm³ |
| Trial 1 | 52.2 | 26.8 | 14.1 | 6.5 | 0.4 | 0.26 |
| Trial 2 | 48.4 | 28.1 | 14.1 | 8.5 | 1.0 | 0.29 |
| Product | 29.7 | 46.3 | 19.2 | 4.8 | 0.0 | 0.20 |
| A | | | | | | |
| Product | 68.6 | 27.6 | 3.6 | 0.2 | 0.0 | 0.14 |
| B | | | | | | |

### EXAMPLE 3

### Aspartame Powder Obtained from Milling Compacted Aspartame

Aspartame powder having the desired particle size distribution and bulk density was obtained directly by milling compacted aspartame (NutraSweet GA) using a Mikro-Pulverizer mill (MicroPul Corporation, Summit, N.J.). The results are shown for aspartame powders obtained from two trials having different rotor rotation rates. Trial 1 incorporated a rotor rotation rate of 6500 rpm while Trial 2 used a rotor rotation rate of 5600 rpm. In both trials a feed rate of 120 kg/hr was used.

The particle size distributions and bulk densities of the resulting aspartame powders are shown in Table 3, along with the particle size distributions and bulk densities of Product A (Ajinomoto) and Product B (NutraSweet). The aspartame powders is obtained in Trials 1 and 2 resulted in a particle size distribution in which 56.8 and 48.4 wt. % of the total particles were less than 5 μm, while at the same time having a bulk density of 0.25 and 0.29 g/m³, respectively. The amount of particles in the range of 5-21 μm was around 28 wt. %,thus, the total amount of particles less than about 21 μm was about 85 wt. % and 76 wt. %, respectively. The aspartame powder displayed improved flow properties, better handling and less dustiness when compared to Product A and Product B aspartame powders.

TABLE 3
Properties of Aspartame Powders Obtained
From Milling Compacted Aspartame

| Aspar- | | | | | | Bulk |
|---|---|---|---|---|---|---|
| tame | wt. % | | | | | density |
| powder | <5 μm | 5-21 μm | 21-51 μm | 51-87 μm | +87 μm | g/cm³ |
| Trial 1 | 56.8 | 28.0 | 8.9 | 4.2 | 2.1 | 0.25 |
| Trial 2 | 48.4 | 28.1 | 14.1 | 8.5 | 1.0 | 0.29 |
| Product | 29.7 | 46.3 | 19.2 | 4.8 | 0.0 | 0.20 |
| A | | | | | | |
| Product | 68.6 | 27.6 | 3.6 | 0.2 | 0.0 | 0.14 |
| B | | | | | | |

### EXAMPLE 4

### Powder Obtained from Air Classification of Milled Aspartame

A representative aspartame powder that was produced by milling compacted aspartame (NutraSweet GA) as described in Example 3 was further classified to produce aspartame powder according to the present invention. The powder was classified using a Hosokawa Micron Separator, Model No. MS-2 air classifier (Hosokawa Micron Powder Systems, Summit, N.J.) equipped with a #2 classifier rotor mounted in vertical position with a 3″ screen. The speed of the rotor was set at 1500 rpm while the feed rate was maintained at 1.7 kg/min. The vacuum level of the classifier was maintained at 22″. These conditions resulted in a reduction of the portion of particles smaller than about 21 μm, and in particular a reduction of particles smaller than 5 μm, compared to the starting aspartame powder.

The results are shown in Table 4, which shows the properties of aspartame powders of three trials. The aspartame powders produced had 13.3-13.9 wt. % of particles less than 5 μm and 20.5-20.3 wt. % between 5-21 μm, resulting in a total amount of particles less than 21 μm of between 33.8-34.2 wt %. The aspartame powders had a bulk density in the range of 0.52-0.54 g/cm³ which is significantly greater than the bulk density of Product A (Ajinomoto) and Product B (NutraSweet). The aspartame powders also exhibited less dusting and improved flow properties when compared to Product A and Product B aspartame powders.

TABLE 4
Properties of Aspartame Powder Obtained From
Air Classification Of Milled Aspartame

| Aspar- | | | | | | Bulk |
|---|---|---|---|---|---|---|
| tame | wt. % | | | | | density |
| powder | <5 μm | 5-21 μm | 21-51 μm | 51-87 μm | +87 μm | g/cm³ |
| starting | 57.9 | 28.8 | 9.6 | 3.6 | 0.2 | 0.25 |
| aspar- | | | | | | |
| tame | | | | | | |
| Trial 1 | 13.3 | 20.5 | 34.8 | 22.6 | 8.9 | 0.54 |
| Trial 2 | 13.9 | 23.3 | 37.5 | 18.5 | 6.8 | 0.52 |
| Trial 3 | 13.4 | 21.7 | 36.6 | 20.5 | 7.8 | 0.53 |
| Product | 29.7 | 46.3 | 19.2 | 4.8 | 0.0 | 0.20 |
| A | | | | | | |
| Product | 68.6 | 27.6 | 3.6 | 0.2 | 0.0 | 0.14 |
| B | | | | | | |

What is claimed is:

1. An aspartame powder comprising aspartame particles having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm.

2. The aspartame powder of claim 1, wherein said aspartame powder has the following size distribution: about 30 to about 60 wt. % of the particles are smaller than 5 μm, about 20 to about 30 wt. % of the particles are between 5-21 μm; about 5 to about 15 wt. % of the particles are between 21-51 μm; about 2 to about 10 wt. % of the particles are between 51-87 μm; and less than about 5 wt. % of the particles are greater than 87 μm.

3. The aspartame powder of claim 1 wherein said aspartame powder comprises about 40 to about 95 wt. % of particles less than about 20 μm.

4. The aspartame powder of claim 1, wherein said aspartame powder has a bulk density of 0.15-0.35 g/cm³.

5. The aspartame powder of claim 1, wherein said aspartame powder has a bulk density of 0.20-0.35 g/cm³.

6. A process for the preparation of an aspartame powder comprising aspartame particles having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm, comprising milling compacted aspartame by grinding or pulverizing under conditions sufficient to obtain said particle size distribution of said aspartame powder.

7. The process according to claim 6, wherein said milling comprises the sub-steps of (i) feeding the compacted aspartame into the mill at a feed rate of 250-450 kg/hr, and (ii) milling said compacted aspartame by use of a grinding rotor rotating at 3000-5000 rpm to produce said particle size distribution of said aspartame powder.

8. The process according to claim 6, wherein said milling comprises the sub-steps of (i) feeding the compacted aspartame into the mill at a feed rate of 100-150 kg/hr, and (ii) milling said compacted aspartame by use of a grinding rotor rotating at 2350-5600 rpm, (iii) collecting the fraction of particles produced by said milling that is larger than about 149 μm by use of a collection screen, and (iv) returning said particles larger than about 149 μm to the impact mill to produce said particle size distribution of said aspartame powder.

9. The process according to claim 6, wherein the amount of said fraction of particles less than about 20 μm of the said aspartame powder is between about 40 to about 95 wt. %.

10. The process according to claim 6, wherein the said aspartame powder produced has a bulk density of 0.15-0.35 g/cm³.

11. The process according to claim 6, wherein the aspartame powder produced has a bulk density of 0.20-0.35 g/cm³.

12. An aspartame powder comprising aspartame particles having the following size distribution: about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm.

13. The aspartame powder of claim 12, wherein said aspartame powder has the following size distribution: about 10 to about 30 wt. % of the particles are smaller than 5 μm, about 10 to about 30 wt. % of the particles are between 5-21 μm; about 30 to about 50 wt. % of the particles are between 21-51 μm; about 15 to about 25 wt. % of the particles are between 51-87 μm; and less than about 10 wt. % of the particles are greater than 87 μm.

14. The aspartame powder of claim 12, wherein said aspartame powder comprises about 20 to about 50 wt. % of the particles less than about 20 μm.

15. The aspartame powder of claim 12, wherein said aspartame powder has a bulk density of 0.35-0.70 g/cm³.

16. The aspartame powder of claim 12, wherein said aspartame powder has a bulk density of 0.45-0.70 g/cm³.

17. A process for the preparation of an aspartame powder comprising aspartame particles having a size distribution of about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm, comprising the steps of (i) milling compacted aspartame by grinding or pulverizing under conditions sufficient to obtain aspartame particles having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm; (ii) classifying the aspartame particles produced in step (i) by means of an air classifier; and (iii) recovering aspartame particles having said particle size distribution of about 5 to about 30 wt. % of the particles are smaller than 5 mm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm.

18. The process according to claim 17, wherein said milling comprises the sub-steps of (i) feeding said compacted aspartame into the mill at a feed rate of 250-450 kg/hr, and (ii) milling said compacted aspartame by use of a grinding rotor rotating at 3000-5000 rpm to produce said particle size distribution of said aspartame powder.

19. The process according to claim 17, wherein said milling comprises the sub-steps of (i) feeding said compacted aspartame into the grinder at a feed rate of 100-150 kg/hr, (ii) milling said compacted aspartame by use of a grinding wheel rotating at 2350-5600 rpm to produce said aspartame powder, (iii) collecting the fraction of particles produced by said grinding that is larger than about 149 μm by use of a retain screen, and (iv) returning said particles larger than about 149 μm to the impact mill to produce said particle size distribution of said aspartame powder.

20. The process according to claim 17, wherein said classifying comprises the steps of (i) feeding said milled aspartame powder into the classifier at a feed rate of about 1 to about 2.5 kg/min, (ii) maintaining the classifier rpm at about 1000 to about 1700 rpm, and (iii) maintaining an air flow corresponding to between 18-30″ of vacuum.

21. A tabletop sweetener comprising aspartame powder having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm.

22. The tabletop sweetener of claim 21, wherein said tabletop sweetener is comprised of aspartame powder having the following size distribution: about 30 to about 60 wt. % of the particles are smaller than 5 μm, about 20 to about 30 wt. % of the particles are between 5-21 μm; about 5 to about 15 wt. % of the particles are between 21-51 μm; about 2 to about 10 wt. % of the particles are between 51-87 μm; and less than about 5 wt. % of the particles are greater than 87 μm.

23. The tabletop sweetener of claim 21 wherein said aspartame powder comprises about 40 to about 95 wt. % of particles less than about 20 μm.

24. The tabletop sweetener of claim 21 wherein said aspartame powder has a bulk density of 0.15-0.35 g/cm³.

25. The tabletop sweetener of claim 21 wherein said aspartame powder has a bulk density of 0.20-0.35 g/cm³.

26. A tabletop sweetener comprising aspartame powder having the following size distribution: about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm.

27. The tabletop sweetener of claim 26, wherein said tabletop sweetener is comprised of aspartame powder having the following size distribution: about 10 to about 30 wt. % of the particles are smaller than 5 μm, about 10 to about 30 wt. % of the particles are between 5-21 μm; about 30 to about 50 wt. % of the particles are between 21-51 μm; about 15 to about 25 wt. % of the particles are between 51-87 μm; and less than about 10 wt. % of the particles are greater than 87 μm.

28. The tabletop sweetener of claim 26 wherein said aspartame powder comprises about 20 to about 50 wt. % of particles less than about 20 μm.

29. The tabletop sweetener of claim 26 wherein said aspartame powder has a bulk density of 0.35-0.70 g/cm³.

30. The tabletop sweetener of claim 26 wherein said aspartame powder has a bulk density of 0.45-0.70 g/cm³.

31. A powdered soft drink comprising aspartame powder having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm.

32. The powdered soft drink of claim 31, wherein said powdered soft drink is comprised of aspartame powder having the following size distribution: about 30 to about 60 wt. % of the particles are smaller than 5 μm, about 20 to about 30 wt. % of the particles are between 5-21 μm; about 5 to about 15 wt. % of the particles are between 21-51 μm; about 2 to about 10 wt. % of the particles are between 51-87 μm; and less than about 5 wt. % of the particles are greater than 87 μm.

33. The powdered soft drink of claim 31 wherein said aspartame powder comprises about 40 to about 95 wt. % of particles less than about 20 μm.

34. The powdered soft drink of claim 31 wherein said aspartame powder has a bulk density of 0.15-0.35 g/cm³.

35. The powdered soft drink of claim 31 wherein said aspartame powder has a bulk density of 0.20-0.35 g/cm³.

36. A powdered soft drink comprising aspartame powder having the following size distribution: about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm.

37. The powdered soft drink of claim 36 wherein said powdered soft drink is comprised of aspartame powder having the following size distribution: about 10 to about 30 wt. % of the particles are smaller than 5 μm, about 10 to about 30 wt. % of the particles are between 5-21 μm; about 30 to about 50 wt. % of the particles are between 21-51 μm; about 15 to about 25 wt. % of the particles are between 51-87 μm; and less than about 10 wt. % of the particles are greater than 87 μm.

38. The powdered soft drink of claim 36 wherein said aspartame powder comprises about 20 to about 50 wt. % of particles less than about 20 μm.

39. The powdered soft drink of claim 36 wherein said aspartame powder has a bulk density of 0.35-0.70 g/cm³.

40. The powdered soft drink of claim 36 wherein said aspartame powder has a bulk density of 0.45-0.70 g/cm³.

41. A chewing gum composition comprising aspartame powder having the following size distribution: about 30 to about 90 wt. % of the particles are smaller than 5 μm; about 10 to about 30 wt. % of the particles are between 5-21 μm; about 1 to about 25 wt. % of the particles are between 21-51 μm; about 0 to about 20 wt. % of the particles are between 51-87 μm; and less than about 10 wt. % of the particles are greater than 87 μm.

42. The chewing gum composition of claim 41, wherein said chewing gum composition is comprised of aspartame powder having the following size distribution: about 30 to about 60 wt. % of the particles are smaller than 5 μm, about 20 to about 30 wt. % of the particles are between 5-21 μm; about 5 to about 15 wt. % of the particles are between 21-51 μm; about 2 to about 10 wt. % of the particles are between 51-87 μm; and less than about 5 wt. % of the particles are greater than 87 μm.

43. The chewing gum composition of claim 41 wherein said aspartame powder comprises about 40 to about 95 wt. % of particles less than about 20 μm.

44. The chewing gum composition of claim 41 wherein said aspartame powder has a bulk density of 0.15-0.35 g/cm³.

45. The chewing gum composition of claim 41 wherein said aspartame powder has a bulk density of 0.20-0.35 g/cm³.

46. A chewing gum composition comprising aspartame powder having the following size distribution: about 5 to about 30 wt. % of the particles are smaller than 5 μm; about 5 to about 30 wt. % of the particles are between 5-21 μm; about 20 to about 50 wt. % of the particles are between 21-51 μm; about 10 to about 25 wt. % of the particles are between 51-87 μm; and less than about 15 wt. % of the particles are greater than 87 μm.

47. The chewing gum composition of claim 46 wherein said chewing gum composition is comprised of aspartame powder having the following size distribution: about 10 to about 30 wt. % of the particles are smaller than 5 μm, about 10 to about 30 wt. % of the particles are between 5-21 μm; about 30 to about 50 wt. % of the particles are between 21-51 μm; about 15 to about 25 wt. % of the particles are between 51 -87 μm; and less than about 10 wt. % of the particles are greater than 87 μm.

48. The chewing gum composition of claim 46 wherein said aspartame powder comprises about 20 to about 50 wt. % of particles less than about 20 μm.

49. The chewing gum composition of claim 46 wherein said aspartame powder has a bulk density of 0.35-0.70 g/cm³.

50. The chewing gum composition of claim 46 wherein said aspartame powder has a bulk density of 0.45-0.70 g/cm³.
